(19) United States
(12) Patent Application Publication
(10) Pub. No.: US 2025/0356550 A1
(43) Pub. Date: Nov. 20, 2025

(54) METHOD AND DEVICE FOR GENERATING SEM IMAGE

(71) Applicants: SAMSUNG ELECTRONICS CO., LTD., Suwon-si (KR); SEOUL NATIONAL UNIVERSITY R&DB FOUNDATION, Seoul (KR)

(72) Inventors: Jaehoon KIM, Seoul (KR); Do-Nyun KIM, Seoul (KR); Jaekyung LIM, Seoul (KR); YunHyoung NAM, Seoul (KR)

(73) Assignees: SAMSUNG ELECTRONICS CO., LTD., Suwon-si (KR); SEOUL NATIONAL UNIVERSITY R&DB FOUNDATION, Seoul (KR)

(21) Appl. No.: 19/046,958

(22) Filed: Feb. 6, 2025

(30) Foreign Application Priority Data
Mar. 18, 2024 (KR) 10-2024-0037374

(51) Int. Cl. G06T 11/20; G06T 7/00; G06T 7/11

(52) U.S. Cl. CPC G06T 11/206; G06T 7/0004; G06T 7/11; G06T 2207/10061; G06T 2207/20081; G06T 2207/20084; G06T 2207/20132; G06T 2207/30148

(57) ABSTRACT

A method includes extracting first feature data by applying a backbone network of a machine learning model to a layout image representing a design for a target pattern, applying a hotspot segmentation network of the machine learning model to the first feature data, the hotspot segmentation network configured to generate a hotspot map representing a hotspot area of the layout image corresponding to a fault, obtaining, from the hotspot segmentation network, second feature data, and generating a scanning electron microscope (SEM) image of a wafer by applying an SEM image generation network of the machine learning model to the first feature data and the second feature data.

### CROSS-REFERENCE TO RELATED APPLICATION

This application is based on and claims priority to Korean Patent Application No. 10-2024-0037374, filed on Mar. 18, 2024, in the Korean Intellectual Property Office, the disclosure of which is incorporated herein by reference in its entirety.

### BACKGROUND

### 1. Field

The disclosure relates to generating a scanning electron microscope (SEM) image.

### 2. Description of Related Art

A lithography process may refer to technology for forming a circuit pattern on a silicon wafer. The lithography process may include applying a photoresist to a wafer on which an oxide film is deposited and selectively emitting light to the photoresist through a mask representing a circuit pattern to print a circuit pattern on a surface of the wafer. As circuit integration increases with the advancement of semiconductor processing technology, the pitch of circuit patterns may decrease, and thus, circuit design is becoming more complex.

Since the size of the light source used in the lithography process may be much larger than the pitch of the circuit pattern used in circuit design, a fault in the wafer may occur during the exposure step. A fault in the wafer may cause defects in semiconductor devices generated from the wafer. Therefore, a fault of the wafer may reduce reliability and productivity of a semiconductor device.

### SUMMARY

Additional aspects will be set forth in part in the description which follows and, in part, will be apparent from the description, or may be learned by practice of the presented embodiments of the disclosure.

According to an aspect of the disclosure, a method may include extracting first feature data by applying a backbone network of a machine learning model to a layout image representing a design for a target pattern, applying a hotspot segmentation network of the machine learning model to the first feature data, the hotspot segmentation network configured to generate a hotspot map representing a hotspot area of the layout image corresponding to a fault, obtaining, from the hotspot segmentation network, second feature data, and generating a scanning electron microscope (SEM) image of a wafer by applying an SEM image generation network of the machine learning model to the first feature data and the second feature data.

The SEM image may include an area in which a fault appears in a portion of the hotspot area.

The obtaining of the second feature data may include extracting, as the second feature data, a result of applying a portion of layers of a plurality of layers of the hotspot segmentation network to the first feature data.

The generating of the SEM image may include generating an intermediate feature by applying a first layer of a plurality of layers of the SEM image generation network to the first feature data, and generating the SEM image by applying a second layer of the plurality of layers of the SEM image generation network to a combination feature obtained based on the intermediate feature and the second feature data.

The first feature data may include a first feature and a second feature, and the extracting of the first feature data may include extracting the first feature by applying a portion of layers of a plurality of layers of the backbone network to the layout image and extracting the second feature by applying remaining layers of the plurality of layers of the backbone network to the first feature.

The obtaining of the second feature data may include obtaining a third feature by applying a first layer of a plurality of layers of the hotspot segmentation network to the second feature, and obtaining a concatenation feature as the second feature data by concatenating the third feature with the first feature, and the method may include generating a hotspot map by applying a second layer of the plurality of layers of the hotspot segmentation network to the concatenation feature.

The generating of the SEM image may include obtaining a fourth feature by applying a first layer of a plurality of layers of the SEM image generation network to the second feature, obtaining an intermediate feature by concatenating the fourth feature with the first feature, and generating the SEM image by applying a second layer of the plurality of layers of the SEM image generation network to a combination feature obtained based on the intermediate feature and the concatenation feature.

The hotspot segmentation network of the machine learning model may be trained using a loss determined based on an optical diameter of a lithography process.

The loss may be determined based on a difference between a ground truth hotspot area and a temporary hotspot area when a size of the temporary hotspot area included in a temporary hotspot map obtained from a temporary hotspot segmentation network is greater than or equal to an area of a circle having the optical diameter.

The ground truth hotspot area may be labeled as a hotspot area corresponding to a fault in a ground truth SEM image mapped to an image for training in a training data set.

The SEM image generation network may be trained using a loss based on an SEM image discrimination network that is configured to determine whether an input image is an SEM image generated by the SEM image generation network or a real SEM image captured by an SEM.

The SEM image generation network may be trained using a loss based on a fault image discrimination network that is configured to determine whether an input image is a fault image cropped from an SEM image generated by the SEM image generation network or a fault image cropped from a real SEM image captured by an SEM.

The method may include displaying a graphical representation indicating an area in the SEM image in which the fault appears wherein the fault corresponds a portion in which a circuit pattern in the SEM image is different from the target pattern.

According to an aspect of the disclosure, an electronic device may include a memory storing instructions, and a processor configured to execute the instructions to extract first feature data by applying a backbone network of a machine learning model to a layout image representing a design for a target pattern, apply a hotspot segmentation network of the machine learning model to the first feature data, the hotspot segmentation network configured to generate a hotspot map representing a hotspot area of the layout image corresponding to a fault, obtain, from the hotspot segmentation network, second feature data, and generate an SEM image of a wafer by applying an SEM image generation network of the machine learning model to the first feature data and the second feature data.

The SEM image may include an area in which a fault appears in a portion of the hotspot area.

The processor may be configured to execute the instructions to obtain the second feature data by extracting a result of applying a portion of layers of a plurality of layers of the hotspot segmentation network to the first feature data.

The processor may be configured to execute the instructions to generate the SEM image by generating an intermediate feature by applying a first layer of a plurality of layers of the SEM image generation network to the first feature data and generating the SEM image by applying a second layer of the plurality of layers of the SEM image generation network to a combination feature obtained based on the intermediate feature and the second feature data.

The first feature data may include a first feature and a second feature, and the processor may be configured to execute the instructions to extract the first feature data by extracting the first feature by applying a portion of layers of a plurality of layers of the backbone network to the layout image, and extracting the second feature by applying remaining layers of the plurality of layers of the backbone network to the first feature.

The processor may be configured to execute the instructions to obtain the second feature data by obtaining a third feature by applying a first layer of a plurality of layers of the hotspot segmentation network to the second feature, and obtaining a concatenation feature as the second feature data by concatenating the third feature with the first feature, and the processor may be further configured to execute the instructions to generate a hotspot map by applying a second layer of the plurality of layers of the hotspot segmentation network to the concatenation feature.

According to an aspect of the disclosure, a non-transitory, computer-readable storage medium may store instructions that, when executed by a processor, cause the processor to extract first feature data by applying a backbone network of a machine learning model to a layout image representing a design for a target pattern, input the first feature data to a hotspot segmentation network of the machine learning model, the hotspot segmentation network configured to generate a hotspot map representing a hotspot area of the layout image corresponding to a fault, generate second feature data by applying the hotspot segmentation network to the first feature data, input the first feature data and the second feature data to an SEM image generation network of the machine learning model, and generate an SEM image of a wafer by applying the SEM image generation network of the machine learning model to the first feature data and the second feature data.

### BRIEF DESCRIPTION OF DRAWINGS

The above and other aspects, features, and advantages of certain embodiments of the disclosure will be more apparent from the following description taken in conjunction with the accompanying drawings, in which:

FIG. 1 is a diagram illustrating an example of an operation of obtaining a hotspot map and a scanning electron microscope (SEM) image from a layout image, according to various embodiments;

FIG. 2 is a flowchart illustrating an example of a method of obtaining an SEM image from a layout image, according to various embodiments;

FIG. 3 is a diagram illustrating an example of an operation of obtaining a segmentation map and an SEM image, according to various embodiments;

FIG. 4 is a diagram illustrating an example of an operation of obtaining a segmentation map and an SEM image, according to various embodiments;

FIGS. 5A and 5B are diagrams illustrating examples of a machine learning model, according to various embodiments;

FIG. 6 is a diagram illustrating training of a hotspot segmentation network, according to various embodiments;

FIG. 7 is a diagram illustrating training of an SEM image generation network using an SEM image discrimination network, according to various embodiments;

FIG. 8 is a diagram illustrating training of an SEM image generation network using a fault image discrimination network, according to various embodiments;

FIG. 9 is a diagram illustrating an example of an operation of displaying a graphical representation indicating an area in which a fault appears in an SEM image, according to various embodiments; and

FIG. 10 is a block diagram illustrating an example of a configuration of an electronic device, according to various embodiments.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects. As used herein, the term “and/or” includes any and all combinations of one or more of the associated listed items. Expressions such as “at least one of,” when preceding a list of elements, modify the entire list of elements and do not modify the individual elements of the list. For example, the expression, “at least one of a, b, and c,” should be understood as including only a, only b, only c, both a and b, both a and c, both b and c, or all of a, b, and c.

As used herein, each of “A or B,” “at least one of A and B,” “at least one of A or B,” “A, B, or C,” “at least one of A, B, and C,” “at least one of A, B, or C,” “one or a combination or two or more of A, B, and C,” and the like may include any one of the items listed together in the corresponding one of the phrases, or all possible combinations thereof.

In the following description, when a component is referred to as being “above” or “on” another component, it may be directly on an upper, lower, left, or right side of the other component while making contact with the other component or may be above an upper, lower, left, or right side of the other component without making contact with the other component.

Terms such as first, second, etc. may be used to describe various components, but are used only for the purpose of distinguishing one component from another component. These terms do not limit the difference in the material or structure of the components. For example, a “first” component may be referred to as a “second” component, and similarly, the “second” component may also be referred to as the “first” component.

It should be noted that when one component is described as being “connected,” “coupled,” or “joined” to another component, the first component may be directly connected, coupled, or joined to the second component, or a third component may be “connected,” “coupled,” or “joined” between the first and second components.

The use of the term “the” and similar designating terms may correspond to both the singular and the plural, unless the context clearly indicates otherwise. It will be further understood that the terms “comprises/comprising” and/or “includes/including,” when used herein, specify the presence of stated features, integers, steps, operations, elements, and/or components, but do not preclude the presence or addition of one or more other features, integers, steps, operations, elements, components and/or groups thereof.

In addition, terms such as “unit” and “module” described in the specification may indicate a unit that processes at least one function or operation, and this may be implemented as hardware or software, or may be implemented as a combination of hardware and software.

Operations of a method may be performed in an appropriate order unless explicitly described in terms of order. In addition, the use of all illustrative terms (e.g., etc.) is merely for describing technical ideas in detail, and the scope is not limited by these examples or illustrative terms unless limited by the claims.

Unless otherwise defined, all terms used herein including technical and scientific terms have the same meanings as those commonly understood by one of ordinary skill in the art to which this disclosure pertains. Terms such as those defined in commonly used dictionaries are to be interpreted as having a meaning that is consistent with their meaning in the context of the relevant art and are not to be interpreted in an idealized or overly formal sense unless expressly so defined herein.

Hereinafter, example embodiments will be described in detail with reference to the accompanying drawings. The embodiments described below are merely exemplary, and various modifications are possible from these embodiments. In the following drawings, the same reference numerals refer to the same components, and the size of each component in the drawings may be exaggerated for clarity and convenience of description.

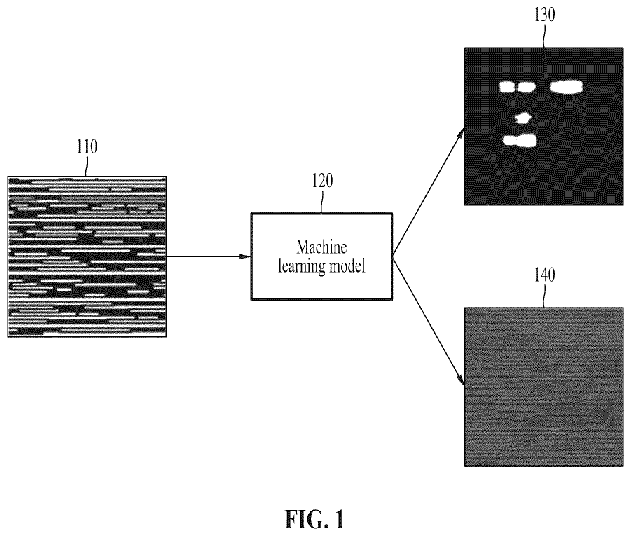

FIG. 1 is a diagram illustrating an example of an operation of obtaining a hotspot map and a scanning electron microscope (SEM) image from a layout image, according to various embodiments.

According to one or more embodiments, an electronic device may generate a hotspot map 130 and an SEM image 140 by applying a machine learning model 120 to a layout image 110.

The layout image 110 may refer to an image of a mask for a circuit pattern to be formed on a wafer. The layout image 110 may indicate a design for a target pattern. The target pattern may refer to a pattern intended to be formed on the wafer.

When performing a lithography process based on the layout image 110, a circuit pattern may be formed on the wafer. For example, in the lithography process, a photoresist is applied on a wafer and light is emitted to a portion of the wafer through a mask corresponding to the layout image 110. The circuit pattern formed on the wafer (hereinafter referred to as an “actual circuit pattern”) may be identical or similar to the target pattern. When at least a portion of the actual circuit pattern is different from the target pattern, the portion of the actual circuit pattern that is different from the target pattern may be determined to be a fault.

The layout image 110 may include a blocking area, which is an area that blocks light by being obscured by a mask, and a passing area, which is an area that allows passage of light. For example, the layout image 110 may include a plurality of blocking areas and a plurality of passing areas, and each blocking area and/or each passing area may include adjacent points.

The fault may include a portion, which corresponds to one blocking area (or one passing area) in the actual circuit pattern, divided into two spaced-apart partial patterns (e.g., a pinch fault). The fault may include a portion, which corresponds to a plurality of blocking areas (or a plurality of passing areas) in the actual circuit pattern, integrated into one partial pattern including adjacent points (e.g., a bridge fault).

The hotspot map 130 may refer to a map indicating an area corresponding to a hotspot among the layout image 110. A hotspot may refer to a partial mask (or a partial pattern), among masks (or target patterns) of the layout image 110, that is likely to cause a fault.

For example, the layout image 110 may include a plurality of unit areas (e.g., pixels), and the hotspot map 130 may include a plurality of unit areas (e.g., pixels). The plurality of unit areas of the layout image 110 may respectively correspond to the plurality of unit areas of the hotspot map 130. A value (e.g., a pixel value) of each unit area of the hotspot map 130 may indicate a possibility of a fault being caused by a partial pattern of a corresponding unit area of the layout image 110. For example, the value of each unit area may have a real number from 0 to 1.

The SEM image 140 may include a simulated image corresponding to an image obtained by photographing a circuit pattern formed on a wafer through a lithography process using an SEM and/or an image having a style of an image obtained by photographing using an SEM. That is, the SEM image 140 output by the machine learning model 120 may be a simulated SEM image generated by the machine learning model 120.

The machine learning model 120 may refer to a machine learning model generated and/or trained to generate the hotspot map 130 and the SEM image 140 from the layout image 110. The machine learning model 120 may be implemented using a neural network (e.g., a convolution neural network (CNN), a generative adversarial network (GAN), Faster regions with convolutional neural network (Faster R-CNN), a region proposal network (RPN), and a residual neural network (ResNet). As described below, the machine learning model 120 may include a backbone network, a hotspot segmentation network, and/or an SEM image generation network.

The SEM image 140 (e.g., a predicted SEM image) generated by the machine learning model 120 may include a circuit pattern to be formed on the wafer when a lithography process if performed based on the layout image 110. For example, the SEM image 140 generated by the machine learning model 120 may show a result of predicting (e.g., simulating) a lithography process based on the layout image 110. Instead of actually performing a lithography process using a mask shown in the layout image 110, the electronic device may generate the SEM image 140 (e.g., the predicted SEM image) using the machine learning model 120 such that an issue, such as a fault, of the layout image 110 may be analyzed without using a material (e.g., a silicon substrate).

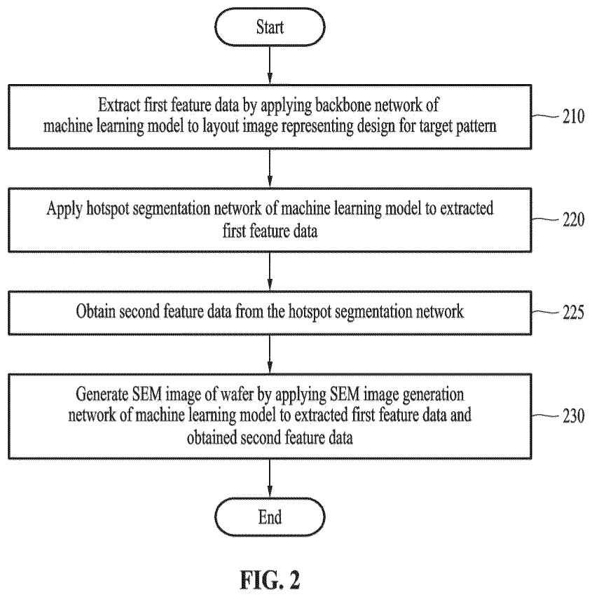

FIG. 2 is a flowchart illustrating an example of a method of obtaining an SEM image from a layout image, according to various embodiments.

In operation 210, the electronic device may extract first feature data by applying a backbone network of a machine learning model (e.g., the machine learning model 120 of FIG. 1) to a layout image (e.g., the layout image 110 of FIG. 1) representing a design for the target pattern.

The machine learning model may be, as described above, a model generated and/or trained to segment a hotspot map and generate an SEM image by being applied to a layout image.

The machine learning model may include a backbone network, a hotspot segmentation network, and an SEM image generation network.

The backbone network may refer to a network trained to output first feature data by being applied to a layout image. The backbone network may be built based on ResNet-101. The first feature data may also be expressed as low-level feature data or a low-level feature.

In operation 220, the electronic device may apply the hotspot segmentation network of the machine learning model to the extracted first feature data.

The hotspot segmentation network may refer to a network generated and/or trained to output the second feature data and a layout image from the first feature data. The hotspot segmentation network may be built based on a Faster R-CNN or a Mask R-CNN.

In operation 225, the electronic device may obtain second feature data from the hotspot segmentation network. The second feature data may also be expressed as high-level feature data or a high-level feature. In addition, since the second feature data is a result output through more layers than the first feature data, the second feature data may be expressed as a relatively higher level than the first feature data.

In operation 230, the electronic device may generate an SEM image (e.g., the SEM image 140 of FIG. 1) of a wafer by applying the SEM image generation network of the machine learning model to the extracted first feature data and the obtained second feature data.

The SEM image generation network may refer to the second feature data and a network generated and/or trained to output the SEM image from the second feature data. The SEM image generation network may be built based on a GAN.

The SEM image generated by the SEM image generation network may include an area in which a fault appears in a portion of the hotspot area. An electronic device may identify information on a target pattern through first feature data and information on a hotspot through second feature data and may generate the SEM image in which a fault appears in a portion of the hotspot map when performing a lithography process using a mask of the target pattern.

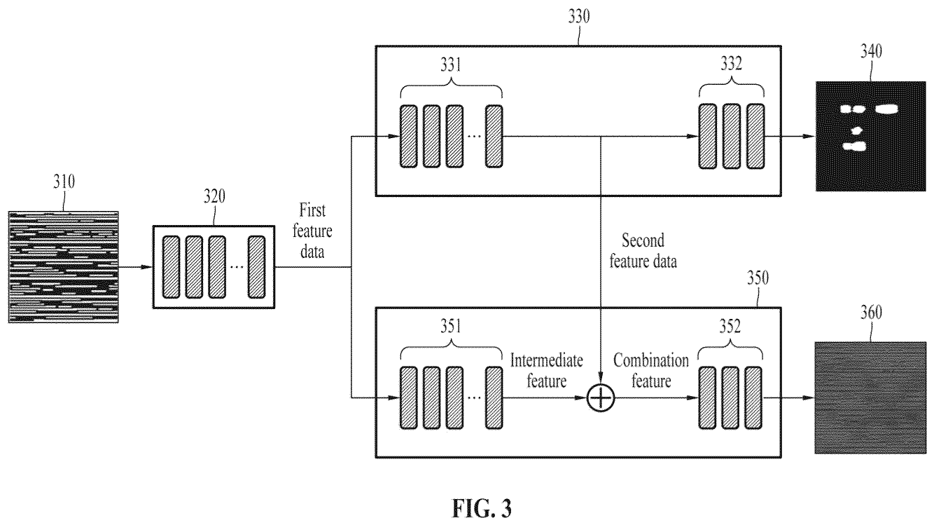

Extracting the first feature data using a machine learning model, obtaining the hotspot map, and generating the SEM image are described in detail below with reference to FIGS. 3 to 5B.

FIG. 3 is a diagram illustrating an example of an operation of obtaining a segmentation map and an SEM image, according to various embodiments.

Referring to FIG. 3, the electronic device may extract first feature data from a layout image 310 by applying a backbone network 320 to the layout image 310. The electronic device may input the first feature data to a hotspot segmentation network 330 and an SEM image generation network 350.

The electronic device may generate second feature data and a hotspot map 340 from the hotspot segmentation network 330. The electronic device may extract, as the second feature data, a result of applying a portion of layers 331 of a plurality of layers of the hotspot segmentation network 330 to the first feature data. The electronic device may input the second feature data to the SEM image generation network 350. The electronic device may generate the hotspot map 340 based on a result of applying remaining layers 332 of the plurality of layers of the hotspot segmentation network 330 to the second feature data.

The electronic device may generate an SEM image 360 from the first feature data and the second feature data using the SEM image generation network 350. The electronic device may generate an intermediate feature by applying a first layer 351 of a plurality of layers of the SEM image generation network 350 to the first feature data.

The electronic device may obtain a combination feature based on the generated intermediate feature and the second feature data. The combination feature may refer to a feature generated based on the intermediate feature and the second feature data. For example, the electronic device may obtain the combination feature by performing an addition operation (e.g., an element-wise addition operation) of the intermediate feature and the second feature data.

The electronic device may generate the SEM image 360 by applying a second layer 352 of the plurality of layers of the SEM image generation network 350 to the combination feature.

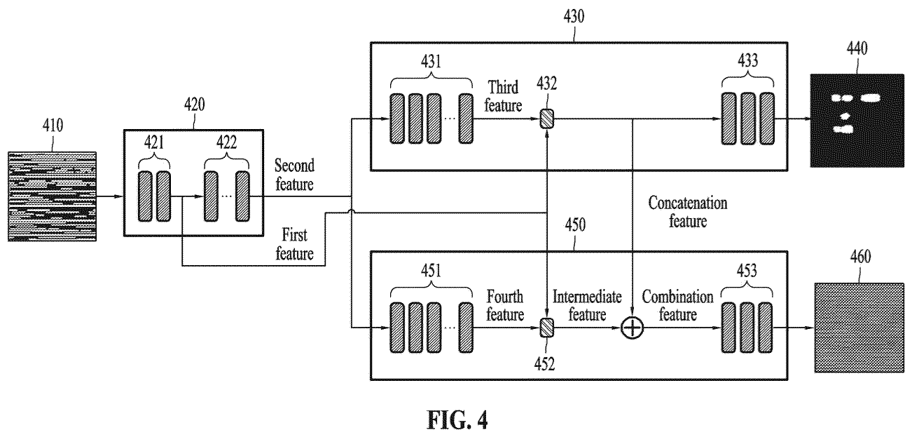

FIG. 4 is a diagram illustrating an example of an operation of obtaining a segmentation map and an SEM image, according to various embodiments.

Referring to FIG. 4, the electronic device may extract first feature data from a layout image 410 by applying a backbone network 420 to the layout image 410. The first feature data may include a first feature and a second feature. The first feature may refer to a feature obtained by applying a portion of layers 421 of a plurality of layers of the backbone network 420 to the layout image 410. The second feature may refer to a feature obtained by applying all of the plurality of layers (e.g., the portion of layers 421 and remaining layers 422) of the backbone network 420 to the layout image 410. For example, the electronic device may extract the first feature by applying the portion of layers 421 of the plurality of layers of the backbone network 420 to the layout image 410. The electronic device may extract the second feature by applying the remaining layers 422 of the plurality of layers of the backbone network 420 to the extracted first feature.

The electronic device may input the first feature and the second feature to a hotspot segmentation network 430 and an SEM image generation network 450.

The electronic device may generate a third feature by applying a first layer 431 of a plurality of layers of the hotspot segmentation network 430 to the second feature. The electronic device may generate a concatenation feature as second feature data by concatenating the third feature with the first feature. The second feature data may include the concatenation feature. The concatenation feature may be generated by performing a concatenation operation on the third feature and the first feature. For example, the hotspot segmentation network 430 may include a concatenation layer 432 that performs a concatenation operation and may generate the concatenation feature by applying the concatenation layer 432 to the first feature and the third feature.

The electronic device may generate a hotspot map 440 by applying a second layer 433 of the plurality of layers of the hotspot segmentation network 430 to the concatenation feature.

The electronic device may generate an SEM image 460 by applying the SEM image generation network 450 to the first feature, the second feature, and the concatenation feature.

The electronic device may generate a fourth feature by applying a first layer 451 of a plurality of layers of the SEM image generation network 450 to the second feature. The electronic device may generate an intermediate feature by concatenating the fourth feature with the first feature. As in the hotspot segmentation network 430, the intermediate feature may be generated by performing a concatenation operation on the fourth feature and the concatenation feature. For example, the SEM image generation network 450 may include a concatenation layer 452 that performs a concatenation operation, and the electronic device may generate the intermediate feature by applying the concatenation layer 452 to the fourth feature and the concatenation feature.

The electronic device may generate the SEM image 460 by applying a second layer 453 of the plurality of layers of the SEM image generation network 450 to the combination feature generated based on the intermediate feature and the concatenation feature. As described above with reference to FIG. 3, the electronic device may generate the combination feature by performing an addition operation (e.g., an element-wise addition operation) on the intermediate feature and the concatenation feature.

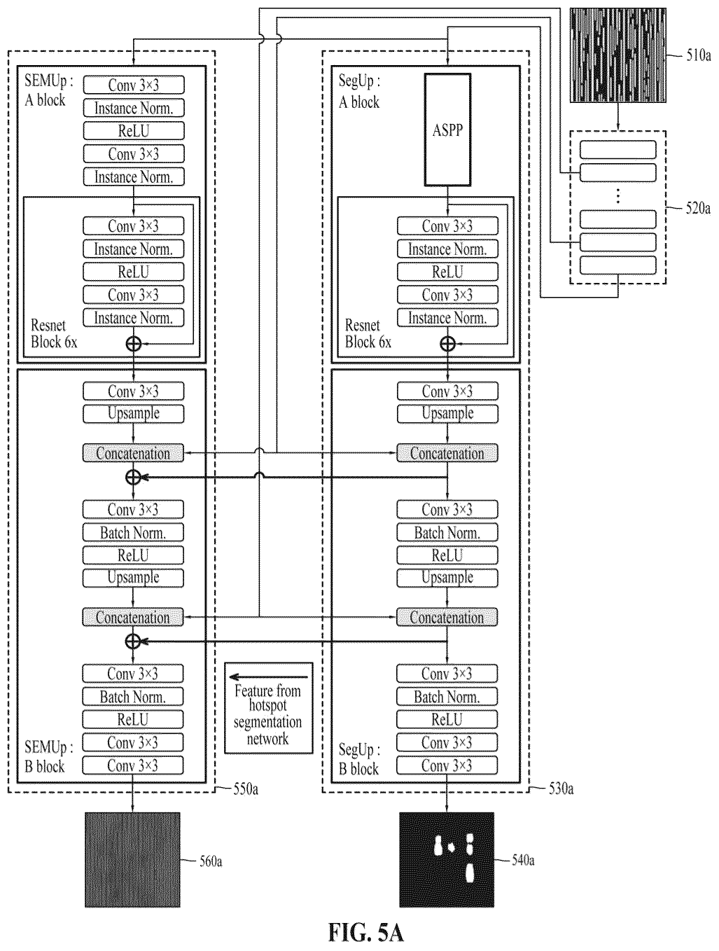

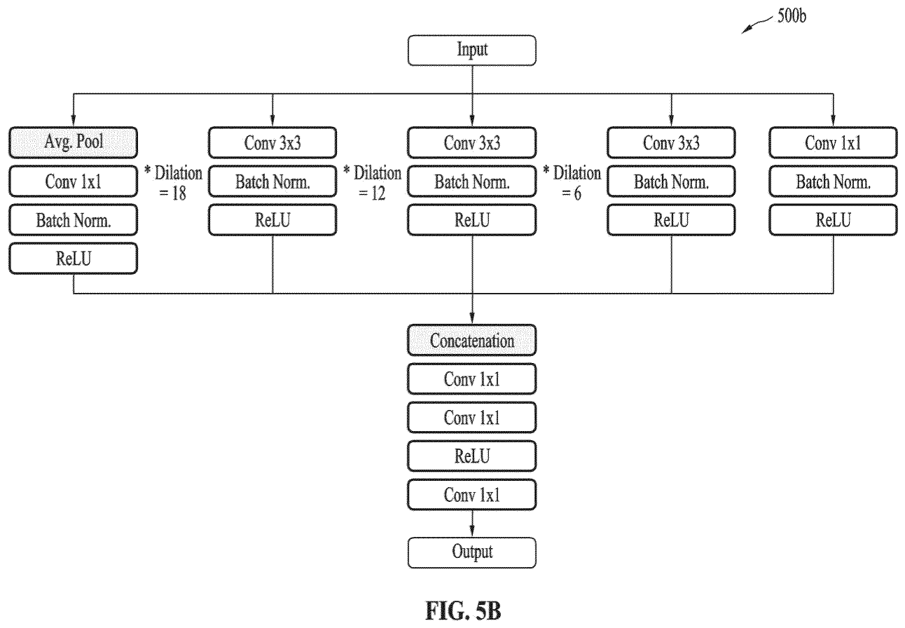

FIGS. 5A and 5B are diagrams illustrating examples of a machine learning model, according to various embodiments.

Referring to FIG. 5A, a machine learning model may include a backbone network 520a, a hotspot segmentation network 530a, and an SEM image generation network 550a.

The backbone network 520a may be a network based on ResNet-101.

The hotspot segmentation network 530a may include a first block (e.g., SegUp A block) and a second block (e.g., SegUp B block).

The first block may include an atrous spatial pyramid pooling (ASPP) module 500b and a Resnet Block 6× module. In FIG. 5B, an example of the ASPP module 500b is shown. The ASPP module 500b may include applying an input to each of five branches (e.g., a first branch to a fifth branch).

The first branch may include a lxi convolution layer (e.g., Conv 1×1 of FIG. 5B), a batch normalization layer (e.g., Batch Norm of FIG. 5B), and a gradient function layer (e.g., a rectified linear unit layer, or a ReLU of FIG. 5B). The second branch may include a 3×3 convolutional layer (e.g., Conv 3×3 of FIG. 5B) with a dilation value of “6,” a batch normalization layer, and a gradient function layer. A third branch may include a 3×3 convolutional layer (e.g., Conv 3×3 of FIG. 5B) with a dilation value of “12,” a batch normalization layer, and a gradient function layer. A fourth branch may include a 3×3 convolution layer (e.g., Conv 3×3 of FIG. 5B) with a dilation value of “18,” a batch normalization layer, and a gradient function layer. A fifth branch may include an average pooling layer (e.g., Avg. Pool of FIG. 5B), a lxi convolution layer (e.g., Conv 1×1 of FIG. 5B), a batch normalization layer, and a gradient function layer.

The ASPP module 500b may perform a concatenation operation on features output from the five branches. Thereafter, the ASPP module 500b may apply a lxi convolution layer (e.g., Conv 1×1 of FIG. 5B), a 1×1 convolution layer (e.g., Conv 1×1 of FIG. 5B), a gradient function layer, and a 1×1 convolution layer (e.g., Conv 1×1 of FIG. 5B) to a result of performing the concatenation operation. The electronic device may obtain an output of the ASPP module 500b.

Referring again to FIG. 5A, the Resnet Block 6× module may apply layers to the output of the ASPP module 500b. For example, the Resnet Block 6× module may perform an addition operation (e.g., an element-wise addition operation) on the output of the ASPP module 500b and a result of applying a 3×3 convolution layer (e.g., Conv 3×3 of FIG. 5A), an instance normalization layer (e.g., Instance Norm. of FIG. 5A), a gradient function layer, a 3×3 convolution layer (e.g., Conv 3×3 of FIG. 5A), and an instance normalization layer to the output of the ASPP module 500b. The electronic device may obtain an output of the Resnet Block 6× module as an output of the first block. The output of the first block may be transferred to the second block.

The second block may use the output of the first block as an input. The second block may include a 3×3 convolution layer (e.g., Conv 3×3 of FIG. 5A), an upsampling layer (e.g., Upsample of FIG. 5A), a concatenation layer, a batch normalization layer, and a gradient function layer, and the layers may be placed in the order shown in FIG. 5A. As shown in FIG. 5A, a concatenation feature (e.g., second feature data) determined in the second block may be transferred to the SEM image generation network 550a. The electronic device may generate a hotspot map 540a from a layout image 510a using the hotspot segmentation network 530a.

The SEM image generation network 550a may include a third block (e.g., SEMUp A block) and a fourth block (e.g., SEMUp B block).

The third block may include a 3×3 convolutional layer (e.g., Conv 3×3 of FIG. 5A), an instance normalization layer, a gradient function layer, a 3×3 convolutional layer (e.g., Conv 3×3 of FIG. 5A), an instance normalization layer, and a Resnet Block 6×. The Resnet Block 6× module included in the third block of the SEM image generation network 550a may include a 3×3 convolution layer (e.g., Conv 3×3 of FIG. 5A), an instance normalization layer, a gradient function layer, a 3×3 convolution layer (e.g., Conv 3×3 of FIG. 5A), an instance normalization layer, and an addition operation.

The fourth block may use the output of the first block as an input. The second block may include a 3×3 convolution layer (e.g., Conv 3×3 of FIG. 5A), an upsampling layer (e.g., Upsample of FIG. 5A), a concatenation layer, a batch normalization layer, and a gradient function layer, and the layers may be placed in the order shown in FIG. 5A. The electronic device may generate an SEM image 560a using the SEM image generation network 550a.

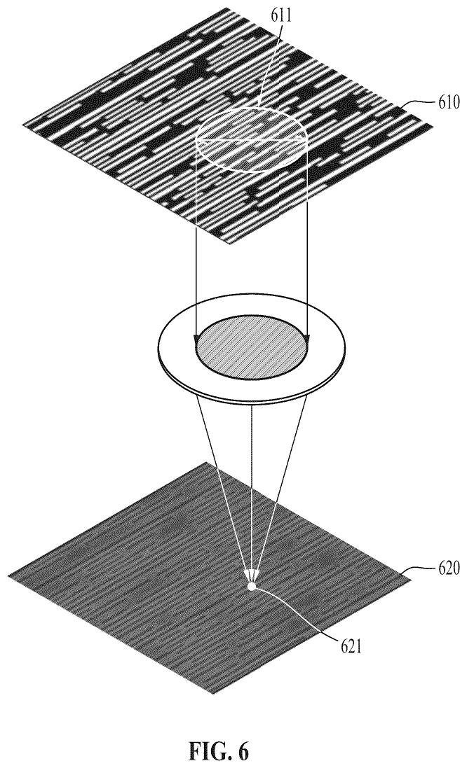

FIG. 6 is a diagram illustrating training of a hotspot segmentation network, according to various embodiments.

A hotspot segmentation network according to one or more embodiments may be trained based on an optical diameter 611. Training of part or all of a machine learning model may be performed by an electronic device, or may be performed by a training device that is separate from the electronic device.

The hotspot segmentation network may be trained based on a loss determined based on the optical diameter 611 of a lithography process. The optical diameter 611 may represent a size (e.g., an area and a diameter) of a portion of a layout image 610 that affects a point 621 of a circuit pattern formed on a wafer. In FIG. 6, a specific region of the layout image 610 affecting the point 621 of the circuit pattern through a device that performs a lithographic process is shown.

For example, the training device may determine the loss based on the optical diameter 611 of a lithography process. The training device may update a parameter of all or part (e.g., a hotspot segmentation network) of the machine learning model based on the determined loss.

The loss may be determined based on a result of comparing the optical diameter 611 (or a size based on the optical diameter 611) with a size of a temporary hotspot area included in a temporary hotspot map obtained from a temporary hotspot segmentation network. The size based on the optical diameter 611 may correspond to a value obtained by multiplying half of the optical diameter 611 squared by the circumference π (i.e., the area of the circle corresponding to the optical diameter 611). The temporary hotspot segmentation network may refer to a hotspot segmentation network that is being trained. A training data set may include the layout image 610 for training (or training first feature data) and a ground truth hotspot area. The training device may obtain the temporary hotspot map from the temporary hotspot segmentation network. The temporary hotspot map may include at least one temporary hotspot area. For example, each temporary hotspot area may include a plurality of adjacent points, and two temporary hotspot areas may be spaced apart from each other in the temporary hotspot map.

For example, the loss may be determined based on a difference between the ground truth hotspot area (or a ground truth partial area) and the temporary hotspot area when the size of the temporary hotspot area is greater than or equal to the size based on the optical diameter 611 (i.e., the area of the circle having the optical diameter 611). A difference between the ground truth hotspot area and the temporary hotspot area may include a difference in probability distributions. An area value of each unit area of the ground truth hotspot area and the temporary hotspot area may indicate a possibility of the corresponding unit area being a hotspot (e.g., the possibility of the corresponding unit area being a partial pattern that causes a fault). The difference in probability distributions may refer to a difference in probability distributions between area values of unit areas included in the ground truth hotspot area and area values of unit areas included in the temporary hotspot area. As described in detail below with reference to Equations (1) and (2), the difference in probability distributions may be determined as a cross-entropy.

The loss may be determined independently of the difference in the probability distributions between the ground truth hotspot area and the temporary hotspot area when the size of the temporary hotspot area is less than the size based on the optical diameter 611 (e.g., the area of the circle having the optical diameter 611). For example, when the size of the temporary hotspot area is less than the size based on the optical diameter 611, the loss may be determined based on a difference between the size of the temporary hotspot area and the size based on the optical diameter 611.

At least a portion of the loss may be determined based on Equations (1) and (2) below.

$$min {L}_{T} s . t . a \leq {\sum }_{p ∈ {Ω}_{i}} {\hat{T}}_{p} \leq b , i = 1 , ... , N \qquad ( 1 )$$

$${L}_{T} = - {\sum }_{N} {\sum }_{p ∈ {Ω}_{i}} {T}_{p} log ( {\hat{T}}_{p} ) + ( 1 - {T}_{p} ) log ( 1 - {\hat{T}}_{p} )$$

$$b = π {( k / 2 )}^{2}$$

Equation (1) describes an example of a loss based on the difference between the temporary hotspot area and the ground truth hotspot area. In Equation (1), L_{T} may denote a partial cross-entropy loss, N may denote a number of temporary hotspot areas included in the temporary hotspot map, a may denote a constant (e.g. a non-negative real number having a value equal to or close to “0”), b may denote the size based on the optical diameter 611, k may denote the optical diameter 611, Ωᵢ may denote an i-th temporary hotspot area (or a set of unit areas included in the i-th temporary hotspot area), p may denote a unit area included in the temporary hotspot area, \hat{T}ₚ may denote an area value (e.g., probability that the unit area is a hotspot) of a unit area p of the temporary hotspot area, and Tₚ may denote an area value of the unit area p of the ground truth hotspot area.

$${L}_{T} + λ {\sum }_{N} C ( {V}_{ì} ) , i = 1 , ... , N \qquad ( 2 )$$

$${V}_{i} = {\sum }_{p ∈ {Ω}_{i}} {\hat{T}}_{p}$$

$$C ( {V}_{i} ) = \{ \begin{matrix}{( {V}_{i} - a )}^{2} , & if {V}_{i} < a \\ {( {V}_{i} - b )}^{2} , & if {V}_{i} < b\end{matrix} \}$$

Equation (2) describes an example of a loss based on the hotspot segmentation network. In Equation 2, Vᵢ may denote a size of the i-th temporary hotspot area, C(Vi) may denote a size by which the size of the i-th temporary hotspot area is out of a size range, where the size range may be from “a” to “b,” and λ may denote a weight (e.g., set to “10”).

The ground truth hotspot area may be labeled as a hotspot area corresponding to a fault shown in a ground truth SEM image 620 mapped to the layout image 610 for training in a training data set. For example, the ground truth SEM image 620 may include a fault area corresponding to a fault. The ground truth hotspot area may be labeled as an area (e.g., an area with the same coordinates or location) that corresponds to the fault area of the ground truth SEM image 620 in the layout image 610. The ground truth hotspot area may be determined as an area that covers the area corresponding to the fault area in the layout image 610.

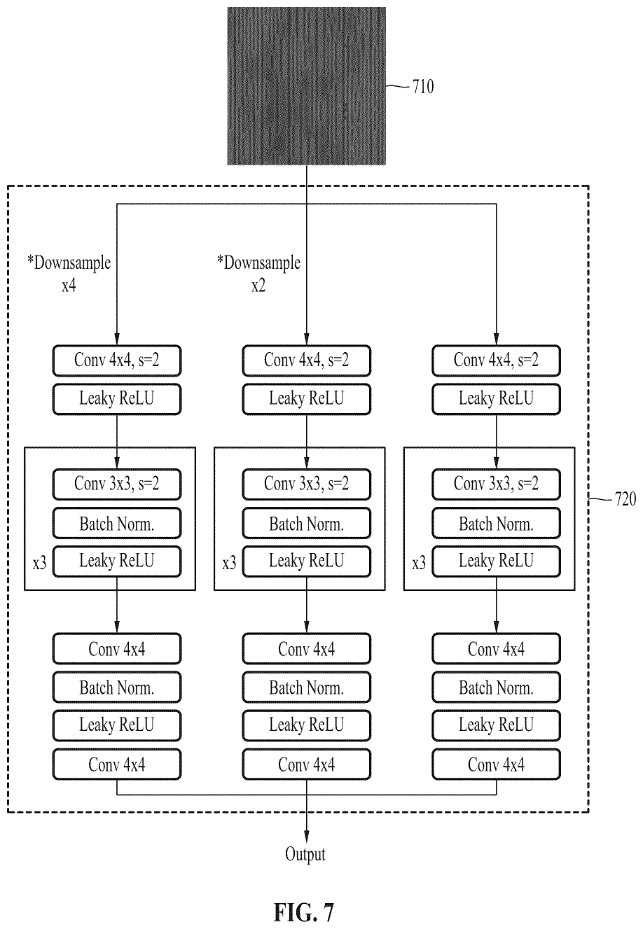

FIG. 7 is a diagram illustrating training of an SEM image generation network using an SEM image discrimination network, according to various embodiments.

The SEM image generation network may be a GAN-based network. For example, the SEM image generation network may be trained based on an SEM image discrimination network 720. The SEM image discrimination network 720 may be a network generated and/or trained to discriminate whether an input image 710 is an SEM image generated by the SEM image generation network or a real SEM image captured by an SEM. The SEM image discrimination network 720 may be applied to a layout image and an input SEM image and may thus output information on whether the input SEM image (e.g., the input image 710) is a real SEM image based on the layout image or a fake SEM image.

For example, a training device may determine a loss based on the SEM image discrimination network 720. The training device may update a parameter of all or part (e.g., an SEM image generation network) of a machine learning model based on the determined loss.

In FIG. 7, an example of a configuration of the SEM image discrimination network 720 is shown. The SEM image discrimination network 720 may output information indicating whether the input image 710 is a real SEM image or a fake SEM image. For example, an output of the SEM image discrimination network 720 may include a probability indicating a possibility of the input image 710 being a real SEM image. The real SEM image may refer to an SEM image captured by an actual SEM. The fake SEM image may refer to an image generated by the SEM image generation network.

The SEM image discrimination network 720 may include a 4×4 convolutional layer with a stride value of “2” (Conv 4×4, s=2), a leaky rectified linear unit layer (Leaky ReLU), a 3×3 convolutional layer with a stride value of “2” (Conv 3×3, s=2), a batch normalization layer, and a down-sampling layer (e.g., a 2× down-sampling layer (Downsample ×2) and a 4× down-sampling layer (Downsample ×4)). The SEM image discrimination network 720 may include layers placed according to the order and structure shown in FIG. 7.

At least a portion of the loss may be determined based on Equations (3) and (4) below.

$${min}_{{G}_{SEM}} ( {max}_{{D}_{SEM}} ( {L}_{G 1} ( {G}_{SEM} , {D}_{SEM} ) ) + {L}_{G 2} ( {G}_{SEM} ) ) \qquad ( 3 )$$

$${L}_{G 1} ( {G}_{SEM} , {D}_{SEM} ) = {E}_{LD , S} [ log {D}_{SEM} ( L D , S ) ] + {E}_{LD} [ log ( 1 - {D}_{SEM} ( L D , {G}_{SEM} ( L D ) ) ) ]$$

$${L}_{G 2} ( {G}_{SEM} ) = {‖ {G}_{SEM} ( L D ) - S ‖}_{1}$$

L_{G1} may denote an adversarial minmax loss, and L_{G2} may denote an L1 loss between a ground truth SEM image and a generated SEM image. D_{SEM} may denote the SEM image discrimination network 720, and G_{SEM} may denote the SEM image generation network. LD may denote a layout image, G_{SEM}(LD) may denote an SEM image (or a fake SEM image) generated based on the layout image LD, and S may denote a ground truth SEM image (or a real SEM image).

$${L}_{FM} ( {G}_{SEM} , {D}_{SEM} ) = {E}_{LD , S} {\sum }_{l} \frac{1}{{N}_{i}} [ {‖ {D}_{SEM}^{( i )} ( L D , S ) - {D}_{SEM}^{( i )} ( L D , {G}_{SEM} ( L D ) ) ‖}_{1} ] \qquad ( 4 )$$

L_{FM} may denote a feature matching loss, l may denote a number of layers of the SEM image discrimination network 720, and Nᵢ may denote a number of elements of an i-th layer.

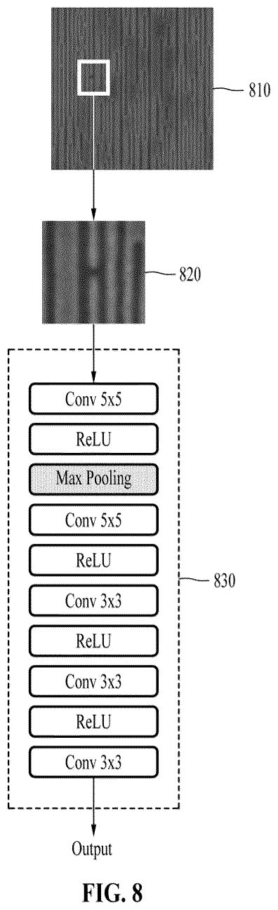

FIG. 8 is a diagram illustrating training of an SEM image generation network using a fault image discrimination network, according to various embodiments.

The SEM image generation network may be trained based on a fault image discrimination network 830. The fault image discrimination network 830 may refer to a network generated and/or trained to discriminate whether an input image 820 is a real fault image or a fake fault image.

The input image 820 may be an image cropped from an original image 810. The original image 810 may be one of a real SEM image or a fake SEM image. As described above, the real SEM image may refer to an SEM image captured by an actual SEM. The fake SEM image may refer to an image generated by the SEM image generation network.

For example, a real fault image may refer to an image in which an area corresponding to a fault is cropped from the real SEM image. The fake fault image may refer to an image in which at least a portion of areas is cropped from the fake SEM image.

An area corresponding to the fault among a ground truth SEM image of the training data set may be labeled in advance. The training device may generate the fake SEM image (e.g., a temporary SEM image) based on a layout image mapped to the ground truth SEM image. The fake fault image may be obtained by cropping an area, from the fake SEM image, which is at a same location and/or coordinates as the area corresponding to the labeled fault in the ground truth SEM image.

For example, the training device may determine a loss based on the fault image discrimination network 830. The training device may update a parameter of all or part (e.g., an SEM image generation network) of a machine learning model based on the determined loss.

In FIG. 8, an example of a configuration of the fault image discrimination network 830 is shown. The fault image discrimination network 830 may output information indicating whether the input image 820 is a real fault image or a fake fault image. For example, the output of the fault image discrimination network 830 may include a probability indicating a possibility of the input image 820 being a real fault image.

The fault image discrimination network 830 may include a 5×5 convolutional layer (e.g., Conv 5×5 of FIG. 8), a gradient function layer (e.g., a ReLU of FIG. 8), a max pooling layer (e.g., Max Pooling of FIG. 8), and a 3×3 convolutional layer (e.g., Conv 3×3 of FIG. 8). The fault image discrimination network 830 may include layers placed according to the order and structure shown in FIG. 8.

At least a portion of the loss may be determined based on Equation (5) below.

$${min}_{{{G}_{SEM}}^{}} ( {max}_{{D}_{HD}} ( {L}_{HD} ( {G}_{SEM} , {D}_{HD} ) ) ) \qquad ( 5 )$$

$${L}_{HD} ( {G}_{SEM} , {D}_{HD} ) = {E}_{S} [ log {D}_{HD} ( {S}^{*} ) ] + {E}_{LD} [ log ( 1 - {D}_{HD} ( {G}_{SEM}^{*} ( L D ) ) ) ]$$

LHD may denote an adversarial min-max loss based on the fault image discrimination network 830. DHD may refer to the fault image discrimination network 830, S* may denote a real fault image cropped from a real SEM image, and G*_{SEM}(LD) may denote a fake fault image cropped from a fake SEM image.

The training device may determine the loss for training a machine learning model based on Equation (6) below.

$${min}_{{G}_{SEM}} ( {max}_{{D}_{SEM}} ( {L}_{G 1} ( {G}_{SEM} , {D}_{SEM} ) ) + {max}_{{D}_{HD}} ( {L}_{HD} ( {G}_{SEM} , {D}_{HD} ) ) + {L}_{G 2} ( {G}_{SEM} ) + {L}_{T} + λ {\sum }_{N} C ( {V}_{i} ) + {L}_{FM} ( {G}_{SEM} , {D}_{SEM} ) ) \qquad ( 6 )$$

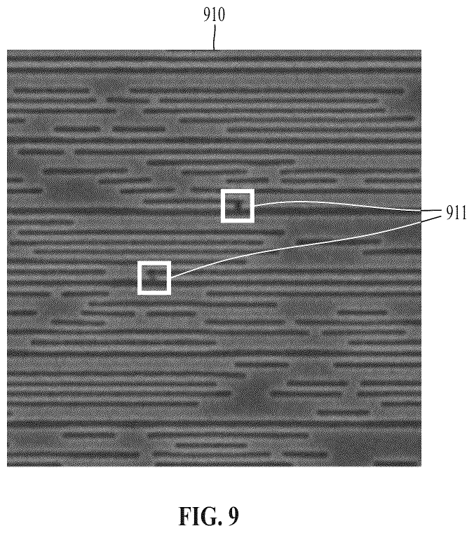

FIG. 9 is a diagram illustrating an example of an operation of displaying a graphical representation indicating an area in which a fault appears in an SEM image, according to various embodiments.

The electronic device may display an SEM image 910 generated based on a machine learning model. The SEM image 910 may include an area corresponding to a fault. The electronic device may display a graphical representation 911 indicating an area, in the generated SEM image 910, in which a fault appears. As described above, a fault may refer to a portion in which a circuit pattern shown in the SEM image 910 is different from a target pattern.

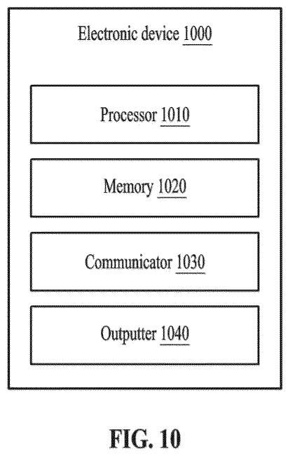

FIG. 10 is a block diagram illustrating an example of a configuration of an electronic device, according to various embodiments.

An electronic device 1000 may include a processor 1010, a memory 1020, a communicator 1030, and an outputter 1040.

The processor 1010 may extract first feature data by applying a backbone network of a machine learning model to a layout image. The processor 1010 may generate second feature data and a hotspot map by applying a hotspot segmentation network to the first feature data. The processor 1010 may generate an SEM image by applying an SEM image generation network to the first feature data and the second feature data.

The memory 1020 may temporarily and/or permanently store at least one of the layout image, the first feature data, the second feature data, the SEM image, the machine learning model, the backbone network, the hotspot segmentation network, and the SEM image generation network. The memory 1020 may store instructions to be executed by the processor 1010 for extracting the first feature data, obtaining the second feature data, obtaining the hotspot map, and/or generating the SEM image. However, these are only examples, and information stored in the memory 1020 is not limited thereto.

The communicator 1030 may transmit or receive at least one of the layout image, the first feature data, the second feature data, the SEM image, the machine learning model, the backbone network, the hotspot segmentation network, and the SEM image generation network to or from an external device (e.g., another electronic device and a server). The communicator 1030 may establish a wired communication channel and/or a wireless communication channel with the external device (e.g., another electronic device and a server) and may establish communication with the external device via a long-range communication network, such as cellular communication, short-range wireless communication, local area network (LAN) communication, Bluetooth™, wireless-fidelity (Wi-Fi) direct or infrared data association (IrDA), a legacy cellular network, a fourth generation (4G) and/or 5G network, next-generation communication, the Internet, or a computer network (e.g., a LAN or a wide area network (WAN)).

The outputter 1040 may output the layout image, the SEM image, and/or a graphical representation. For example, the outputter 1040 may include a display.

The examples described herein may be implemented using hardware components, software components, and/or combinations thereof. A processing device may be implemented using one or more general-purpose or special-purpose computers, such as, for example, a processor, a controller, an arithmetic logic unit (ALU), a digital signal processor (DSP), a microcomputer, a field-programmable gate array (FPGA), a programmable logic unit (PLU), a microprocessor or any other device capable of responding to and executing instructions in a defined manner. The processing device may run an operating system (OS) and one or more software applications that run on the OS. The processing device may also access, store, manipulate, process, and create data in response to execution of the software. For purpose of simplicity, the description of a processing device is used as singular. However, one of ordinary skill in the art will appreciate that a processing device may include multiple processing elements and/or multiple types of processing elements. For example, a processing device may include a plurality of processors, or a single processor and a single controller. In addition, a different processing configuration is possible, such as one including parallel processors.

The software may include a computer program, a piece of code, an instruction, or some combination thereof, to independently or collectively instruct or configure the processing device to operate as desired. The software and/or data may be permanently or temporarily embodied in any type of machine, component, physical or virtual equipment, or computer storage medium or device for the purpose of being interpreted by the processing device or providing instructions or data to the processing device. The software may also be distributed over network-coupled computer systems so that the software is stored and executed in a distributed fashion. The software and data may be stored in a non-transitory computer-readable recording medium.

The methods according to the above-described examples may be recorded in non-transitory computer-readable media including program instructions to implement various operations of the above-described examples. The media may also include the program instructions, data files, data structures, and the like alone or in combination. The program instructions recorded on the media may be those specially designed and constructed for the examples, or they may be of the kind well-known and available to those having skill in the computer software arts. Examples of non-transitory computer-readable media include magnetic media such as hard disks, floppy disks, and magnetic tape; optical media such as compact disc read-only memory (CD-ROM) and a digital versatile disc (DVD); magneto-optical media such as floptical disks; and hardware devices that are specially configured to store and perform program instructions, such as read-only memory (ROM), RAM, flash memory, and the like. Examples of program instructions include both machine code, such as those produced by a compiler, and files containing higher-level code that may be executed by the computer using an interpreter.

At least one of the devices, units, components, modules, units, or the like represented by a block or an equivalent indication in the above embodiments may be physically implemented by analog and/or digital circuits including one or more of a logic gate, an integrated circuit, a microprocessor, a microcontroller, a memory circuit, a passive electronic component, an active electronic component, an optical component, and the like, and may also be implemented by or driven by software and/or firmware (configured to perform the functions or operations described herein).

The above-described hardware devices may be configured to act as one or more software modules in order to perform the operations of the above-described examples, or vice versa.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope as defined by the following claims.

What is claimed is:

1. A method comprising:
extracting first feature data by applying a backbone network of a machine learning model to a layout image representing a design for a target pattern;
applying a hotspot segmentation network of the machine learning model to the first feature data, the hotspot segmentation network configured to generate a hotspot map representing a hotspot area of the layout image corresponding to a fault;
obtaining, from the hotspot segmentation network, second feature data; and
generating a scanning electron microscope (SEM) image of a wafer by applying an SEM image generation network of the machine learning model to the first feature data and the second feature data.

2. The method of claim 1, wherein the SEM image comprises an area in which a fault appears in a portion of the hotspot area.

3. The method of claim 1, wherein the obtaining of the second feature data comprises:
extracting, as the second feature data, a result of applying a portion of layers of a plurality of layers of the hotspot segmentation network to the first feature data.

4. The method of claim 1, wherein the generating of the SEM image comprises:
generating an intermediate feature by applying a first layer of a plurality of layers of the SEM image generation network to the first feature data; and
generating the SEM image by applying a second layer of the plurality of layers of the SEM image generation network to a combination feature obtained based on the intermediate feature and the second feature data.

5. The method of claim 1, wherein the first feature data comprises a first feature and a second feature, and
wherein the extracting of the first feature data comprises:
extracting the first feature by applying a portion of layers of a plurality of layers of the backbone network to the layout image; and
extracting the second feature by applying remaining layers of the plurality of layers of the backbone network to the first feature.

6. The method of claim 5, wherein the obtaining of the second feature data comprises:
obtaining a third feature by applying a first layer of a plurality of layers of the hotspot segmentation network to the second feature; and
obtaining a concatenation feature as the second feature data by concatenating the third feature with the first feature, and
wherein the method further comprises generating a hotspot map by applying a second layer of the plurality of layers of the hotspot segmentation network to the concatenation feature.

7. The method of claim 6, wherein the generating of the SEM image comprises:
obtaining a fourth feature by applying a first layer of a plurality of layers of the SEM image generation network to the second feature;
obtaining an intermediate feature by concatenating the fourth feature with the first feature; and
generating the SEM image by applying a second layer of the plurality of layers of the SEM image generation network to a combination feature obtained based on the intermediate feature and the concatenation feature.

8. The method of claim 1, wherein the hotspot segmentation network of the machine learning model is trained using a loss determined based on an optical diameter of a lithography process.

9. The method of claim 8, wherein the loss is determined based on a difference between a ground truth hotspot area and a temporary hotspot area when a size of the temporary hotspot area included in a temporary hotspot map obtained from a temporary hotspot segmentation network is greater than or equal to an area of a circle having the optical diameter.

10. The method of claim 9, wherein the ground truth hotspot area is labeled as a hotspot area corresponding to a fault in a ground truth SEM image mapped to an image for training in a training data set.

11. The method of claim 1, wherein the SEM image generation network is trained using a loss based on an SEM image discrimination network that is configured to determine whether an input image is an SEM image generated by the SEM image generation network or a real SEM image captured by an SEM.

12. The method of claim 1, wherein the SEM image generation network is trained using a loss based on a fault image discrimination network that is configured to determine whether an input image is a fault image cropped from an SEM image generated by the SEM image generation network or a fault image cropped from a real SEM image captured by an SEM.

13. The method of claim 1, further comprising displaying a graphical representation indicating an area in the SEM image in which the fault appears,
wherein the fault corresponds a portion in which a circuit pattern in the SEM image is different from the target pattern.

14. An electronic device comprising:
a memory storing instructions; and
a processor configured to execute the instructions to:
extract first feature data by applying a backbone network of a machine learning model to a layout image representing a design for a target pattern;
apply a hotspot segmentation network of the machine learning model to the first feature data, the hotspot segmentation network configured to generate a hotspot map representing a hotspot area of the layout image corresponding to a fault;
obtain, from the hotspot segmentation network, second feature data; and
generate a scanning electron microscope (SEM) image of a wafer by applying an SEM image generation network of the machine learning model to the first feature data and the second feature data.

15. The electronic device of claim 14, wherein the SEM image comprises an area in which a fault appears in a portion of the hotspot area.

16. The electronic device of claim 14, wherein the processor is configured to execute the instructions to obtain the second feature data by extracting a result of applying a portion of layers of a plurality of layers of the hotspot segmentation network to the first feature data.

17. The electronic device of claim 14, wherein the processor is configured to execute the instructions to generate the SEM image by:
generating an intermediate feature by applying a first layer of a plurality of layers of the SEM image generation network to the first feature data; and
generating the SEM image by applying a second layer of the plurality of layers of the SEM image generation network to a combination feature obtained based on the intermediate feature and the second feature data.

18. The electronic device of claim 14, wherein the first feature data comprises a first feature and a second feature, and
wherein the processor is configured to execute the instructions to extract the first feature data by:
extracting the first feature by applying a portion of layers of a plurality of layers of the backbone network to the layout image; and
extracting the second feature by applying remaining layers of the plurality of layers of the backbone network to the first feature.

19. The electronic device of claim 18, wherein the processor is configured to execute the instructions to obtain the second feature data by:
obtaining a third feature by applying a first layer of a plurality of layers of the hotspot segmentation network to the second feature; and
obtaining a concatenation feature as the second feature data by concatenating the third feature with the first feature; and
wherein the processor is further configured to execute the instructions to generate a hotspot map by applying a second layer of the plurality of layers of the hotspot segmentation network to the concatenation feature.

20. A non-transitory, computer-readable storage medium storing instructions that, when executed by a processor, cause the processor to:
extract first feature data by applying a backbone network of a machine learning model to a layout image representing a design for a target pattern;
input the first feature data to a hotspot segmentation network of the machine learning model, the hotspot segmentation network configured to generate a hotspot map representing a hotspot area of the layout image corresponding to a fault;
generate second feature data by applying the hotspot segmentation network to the first feature data;
input the first feature data and the second feature data to a scanning electron microscope (SEM) image generation network of the machine learning model; and
generate an SEM image of a wafer by applying the SEM image generation network of the machine learning model to the first feature data and the second feature data.
